(19) United States
(12) Patent Application Publication
(10) Pub. No.: US 2026/0260198 A1
(43) Pub. Date: Sep. 3, 2026

(54) Artificial Intelligence Driven Agricultural Management

(71) Applicant: Endurance Enterprises, LLC, Bellevue, WA (US)

(72) Inventors: James West Johnson, Newport Beach, CA (US); Scott Bauwens, Newbury Park, CA (US); Theodore Scott Travers, Goleta, CA (US); Andrew Chu, Simi Valley, CA (US); Sam Lindquist, San Francisco, CA (US)

(21) Appl. No.: 19/555,398

(22) Filed: Mar. 3, 2026

Related U.S. Application Data
(60) Provisional application No. 63/766,363, filed on Mar. 3, 2025.

(51) Int. Cl. G06Q 10/0637; G06Q 10/0633; G06Q 50/02

(52) U.S. Cl. CPC G06Q 10/06375; G06Q 10/0633; G06Q 50/02

(57) ABSTRACT

An automated agricultural management system collects agronomic, financial, and related operational data for a plantation, collects workflows comprised of a plurality of tasks, and makes use of artificial intelligence including generative artificial intelligence to recommend changes in workflow based on determining that financial benefits outweigh the costs of changing workflow. The agricultural management system demonstrates that changes from legacy to green agronomic practices result in financial benefit thereby creating an economic incentive to change. The agricultural management includes a user interface that propagates information about changes to workers and stakeholders alike and features an alert system to change workflow where emergency situations arise. The agricultural management system provides a simulator to make projections of plantation performance against the market.

### CROSS-REFERENCE TO RELATED APPLICATIONS

This application claims priority to U.S. Provisional Patent Application No. 63/766363, entitled “Artificial Intelligence Driven Agricultural Management,” which was filed on Mar. 3, 2025, the entirety of which is incorporated herein by reference.

### BACKGROUND OF THE INVENTION

A plantation is any business that grows crops, and like any business, plantations involve management. It should be appreciated that the term “plantation,” as used herein, broadly includes any establishment that grows plants commercially, not just those locations that grow field crops, but includes but is not limited to greenhouses, vineyards, orchards and the like. Agricultural management is the making of agronomic and operational decisions for a plantation and translating those decisions into one or more workflows in such a way as to optimize some set of factors. Agronomic decisions include day-to-day field operations and choices of farming techniques as informed by the state of plants, soil, and the environment. Operational decisions relate to business optimization including back-office operations such as finance/accounting, regulatory compliance, and labor management.

Typically, in agricultural management, operational factors, such as profitability, are the primary factors to optimize. However, operational factors are dependent on agronomic factors such as the cost and efficiency of agronomic operations. Accordingly, operational and agronomic factors are inextricably intertwined and, as a result, optimization involves balancing these various factors. For example, profitability may be balanced against compliance with regulatory regimes, sustainability measures, and quality of harvest. Because of this complexity, in many plantations the knowledge of what factors are available and how to modulate those factors, let alone how to optimize the plantation, resides in the personal knowledge of the various plantation managers.

The rise of regenerative farming, i.e., certain agronomic practices designed and selected to ensure long term sustainability of the soil and plants, has only further complicated matters. As expected, with traditional farming methods, a plantation may balance the costs of agricultural inputs, such as seed, fertilizer, and pesticides, against crop yield and profit, with some consideration for the workflow of day-to-day operations. However, regenerative farming techniques take into account soil and plant health measurements to a greater degree than traditional farming. In particular, regenerative farming techniques extrapolate the long-term sustainability of the soil, plants, and general ecosystem from a holistic perspective, giving rise to even more measurements and key performance indicators to track beyond the typical practices of traditional farming.

In general, enterprises in a wide range of verticals are increasingly applying artificial intelligence (“AI”) via machine learning (“ML”) and, more recently, Generative Artificial Intelligence (“GenAI”) techniques to manage complexity and to automate operations. Agricultural technology (“aggrotech”) is no different. However, presently aggrotech does not adequately take into account the economics of regenerative techniques to demonstrate an economic basis as to when to apply those techniques, let alone make use of AI/ML and/or GenAI for this purpose. Much of this is because such automated analysis includes the use of a large amount of data sources, i.e., sensors that, presently, are not widely deployed, but most of all because of the aggrotech knowledge institutionalized not in automated sources, but rather in the human knowledge of the farm managers.

Accordingly, there is a need to reimagine the automation of plantation operations, including agronomic and operational perspectives, which takes full advantage of previously unleveraged data and information, including the human knowledge of farm managers. Beyond realizing operational efficiencies from such automation, there is a need to apply this automation to analysis of regenerative techniques.

### BRIEF DESCRIPTION OF DRAWINGS

The detailed description is described with reference to the accompanying figures. In the figures, the left-most digit of a reference number identifies the figure in which the reference number first appears. The same reference numbers in different figures indicate similar or identical items.

FIG. 1 is a context diagram for artificial intelligence driven agricultural management.

FIG. 2 is a diagram of an exemplary environment for artificial intelligence driven agricultural management.

FIG. 3 is a block diagram for an agricultural management system.

FIG. 4 is a flow chart for dynamic management of plantation agronomic workflow and field operations with artificial intelligence driven agricultural management.

FIG. 5 is a flow chart for performing back-office operations and plantation administration with artificial intelligence-driven agricultural management.

FIG. 6 is a flow chart for performing simulations for plantations with artificial intelligence driven agricultural management.

### DETAILED DESCRIPTION OF THE INVENTION

### Towards Automation of Artificial Intelligence Driven Agricultural Management

Artificial intelligence driven (AID) Agricultural Management involves a comprehensive software architecture that supports automation of agricultural management. Here, the degree of support is sufficient to enable analysis of regenerative farming techniques, and holistically integrate operations (e.g., back-office), agronomics, and overall economic analysis of plantations.

### Input-Process-Output as an Organizing Principle

To understand the overall architecture of AID Agricultural Management, it is also useful to first describe some general computer science architectural philosophy. Computerized automation generally takes the form of starting with some inputs, usually in the form of data or data streams, processing those inputs, and generating outputs also in the form of data or data streams. For example, an arithmetic calculator make take the numbers 1 and 2 as input, process the input by performing addition on the input data, and generate output data in the form of the number 3 representing the sum of the inputs. In fact, this model: Input-Process-Output is one of the first models that systems analysts learn.

Notwithstanding a greater degree of complexity, computerized automation of enterprises still essentially follows the input-process-output model. Because of the complexity, architectural and implementation patterns have emerged. To a very large degree, enterprise automation involves receiving input, storing the input into some sort of computer memory, either long-term storage or short-term working memory, performing processes to transform the input into computer memory, and eventually producing some of the transformed input as generated output.

### RDBMS, AI/ML, and GenAI as a Form of Input-Process-Output Architecture

Over the past decades, the form of the input storage (or “persistence” in computer science terminology), has varied. In the nascent days of computing, input was stored in short term memory, such as core memory. Data was loaded into short term memory, worked out, and then replaced. When the amount of data became too unwieldy to keep loading and reloading, long term memory, such as disk storage was used, placed into computer science data structures providing efficient data record creation, retrieval, update, and delete, and databases were born. The current iteration of databases are databases that use the relational model, called relational databases. However, storing data in databases generally involves a team of expensive specialists to preprocess the data in a format suitable for relational databases.

With the introduction of artificial intelligence in the form of machine learning, machine learning algorithms represent yet another form of processing inputs to generate outputs. The machine learning processing tends towards making predictions based on prior input data. The prior input data is called “training data” because that data represented examples of prior experience which was used to “train” or statistically weight neural networks to represent an amalgamation of that data. In practice, similar to the problems with relational databases, creating data models for training data proved to be difficult, and in some cases preprocessing training data represented over 80% of the cost of creation of AI/ML applications.

With the recent advent of GenAI, inference engines, such as large language models (LLMs), enabled automation to read and interpret data documents without the degree of preprocessing required by relational models and AI/ML applications. The tradeoff to the lowered cost of data preprocessing was that an application making use of an inference engine had the risk of generating errors, called “hallucinations.”

### Application of Relational, AI/ML, and GenAI Data Processing to Agricultural Management Automation

### Introducing Regenerative Farming

Before discussing AID Agricultural Management, it is useful to discuss regenerative farming. With present farming techniques, the soil can be analogized as a sponge that one embeds seeds in to grow plants. Pesticides, fertilizer, and other chemicals, collectively called inputs, along with water, are added to the sponge. Labor, including the use of machinery that uses energy, aid the process of farming along. Finally, sun for photosynthesis completes the equation. The result is plants which are then harvested resulting in produce. Present farming techniques have the benefit of providing industrial crop yields but are harsher on the farming environment than the soil and plants, and the environment generally, evolved in nature to meet. The tradeoff for present farming techniques is higher crop yields in exchange for biologically exhausted and unhealthy soil, unhealthy plants, and lower quality produce.

Regenerative farming practices are typically promoted on grounds of being ecologically sustainable or “green.” However, it can be demonstrated that under some specific circumstances, regenerative farming also provides an economic advantage. Without this knowledge, plantations and/or farms facing tight financial margins might eschew regenerative farming by mistakenly thinking that regenerative farming is a luxury they cannot afford. Advantageously, one of the purposes of automation of agricultural management is to enable the collection of data, and the generation of reports predicting under what circumstances there is an economic advantage by utilizing regenerative techniques.

We describe an Agricultural Management System to implement automation Agricultural Management, which makes use of the relational model, the AI/ML approach, and GenAI. At a general level, the Agricultural Management System receives operational and agronomic input from users, and telemetry input from sensors and outside data feeds. From the information gathered from these sources, i.e., the input, the Agricultural Management System provides reporting and recommendations at both the operation (overall management) perspective and agronomic workflow (day-to-day) perspective. Furthermore, the Agricultural Management System supports identifying and deploying dynamic changes to workflow based on new inputs received substantively in real-time.

### Context of Artificial Intelligence Driven Agricultural Management

### Plantations, farm Roles, and Client Applications

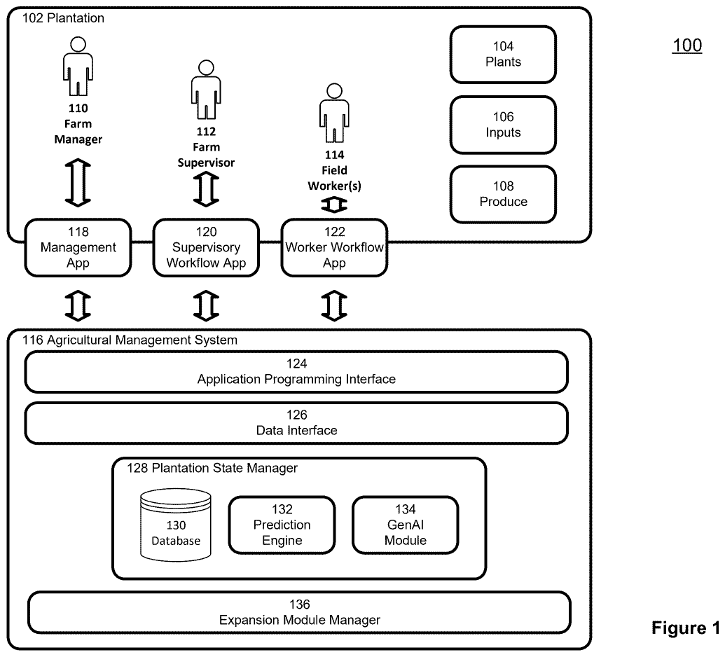

FIG. 1 provides a context diagram 100 of an AID Agricultural Management System. The AID Agricultural Management System automates operation with respect to Plantation 102. Farm 102 grows and cultivates Plants 104. Plants 104 herein are any vegetation cultivated by performing farming techniques by applying Inputs 106 to create Produce 108 for harvest, which in turn is generally brought to market. Inputs 106 include anything applied to Plants 104 during cultivation including (and without limitation) water, feedstock, pesticides, and fertilizer. Produce 108 will vary based on the type of Plantation 102. For example, a Plantation 102 may produce wheat or corn, a Plantation 102 vineyard may produce grapes or tomatoes, a Plantation 102 greenhouse may produce roses, and a Plantation 102 orchard may produce apples, oranges, or avocados.

Like other complex business operations, Plantation 102 utilizes personnel having different roles. One role is a Farm Manager 110 who is responsible for the overall performance of the plantation, including its financial performance, regulatory compliance, and any interaction with third parties such as insurance, vendors, and government. In contrast and focused on internal day-to-day operations, is the role of Farm Supervisor 112. Farm Supervisor 112 is responsible for translating the business goals set by the Farm Manager 110 into workflows that, in turn, are performed by Field Workers 114. Field Workers 114 include a large spectrum of workers ranging from day laborers to employees and semi-permanent contractors, from generalists to specialists and subject matter experts, all of which are orchestrated by Farm Supervisor 112.

The automation of Plantation 102 is performed by the Agricultural Management System 116 which is an automation platform that receives data input from various data sources, performs processing, and generates outputs as described in further detail below. Farm Manager 110, Farm Supervisor 112, and Field Workers 114 interface with the Agricultural Management System 116 via a Management Application (App) 118, Supervisory Workflow App 120, and Worker Workflow App 122, respectively. In general, the Management App 118 is a software application that will be accessed via a laptop or personal computer, for in field and on-site operations, the Supervisory Workflow App 120 and the Worker Workflow App 122 are both software applications that are also accessible on mobile devices such as tablets and mobile smartphones.

Programmatic interfacing is communications with an automation system to make requests and receive responses. Programmatic interfacing with the Agricultural Management System 116, including the Management App 118, Supervisory Workflow App 120, and Worker Workflow App 122, is accomplished via Application Programming Interface (API) 124. API 124 may be implemented as a set of Representational State Transfer (ReST) compliant function calls. Those API 124 function calls are commonly implemented via languages such as script JavaScript and Python, but in some cases are implemented via compiled languages such as C++. Parameter passing to the API 124 functions may be via JavaScript Object Notation (JSON) files.

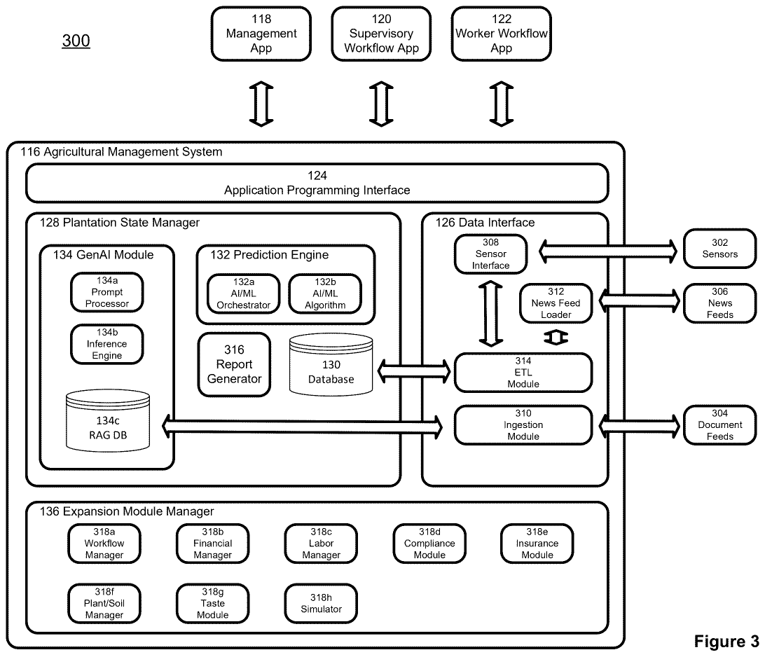

API 124 of the Agricultural Management System 116 is not used just for apps 118, 120, 124, but for any programmatic interfacing. A special case of programmatic interfacing is for Agricultural Management System 116 to receive input data, which is either telemetry from the Plantation 102 or external data regarding the state of the Plantation 102 (sometimes collectively called “Farm State” or more broadly “Plantation State”). Input data is so-called because it acts as an “input” to the Agricultural Management System 116 to which it reacts to. Data Interface 126 is a software module that manages any streams of data or documents to be processed by Agricultural Management System 116. Input data includes sensor telemetry, news feeds, and documents used for Retrieval Augmented Generation (RAG) for GenAI. Data Interface 126 is described in further detail with respect to FIG. 3 below.

The processing of data input via Data Interface 126 and generally received via API 124 is performed by Farm State Manager 128. The Farm State Manager 128 is a software module that orchestrates the storing (also known as “persisting”) of data inputs, performs processing on the data input, and generates outputs. As stated above, Agricultural Management System 116 makes use of all available data processing techniques. Accordingly, Farm State Manager 128 includes a relational database management system (RDBMS) 130, a Prediction Engine 132, which incorporates software AI/ML routines, including predictive routines, and a GenAI Module 134 which performs generative artificial intelligence functions as part of agricultural management for Plantation 102. The internals of Farm State Manager 128 are described in further detail with respect to FIG. 3 below.

Farm State Manager 128 is configured to perform processing on received input data. However, there is a wide range of possible processing. Expansion Module Manager 136 is a software module which manages expansion modules, or application specific software modules, that direct processing on input to generate desired outputs. The operation of the Expansion Module Manager 136 is set forth in greater detail with respect to FIG. 3 below. This discussion includes descriptions of several specific expansion modules including, but not limited to, ad hoc reporting, workflow management, financial management, labor management, insurance management, compliance management and certification.

Accordingly, the Agricultural Management System 116 is configured to receive the full spectrum of input data sufficient to support analysis of regenerative techniques, as well as apply the full range of data processing techniques to automate a Plantation 102.

### Exemplary Environment for Artificial Intelligence Driven Agricultural Management

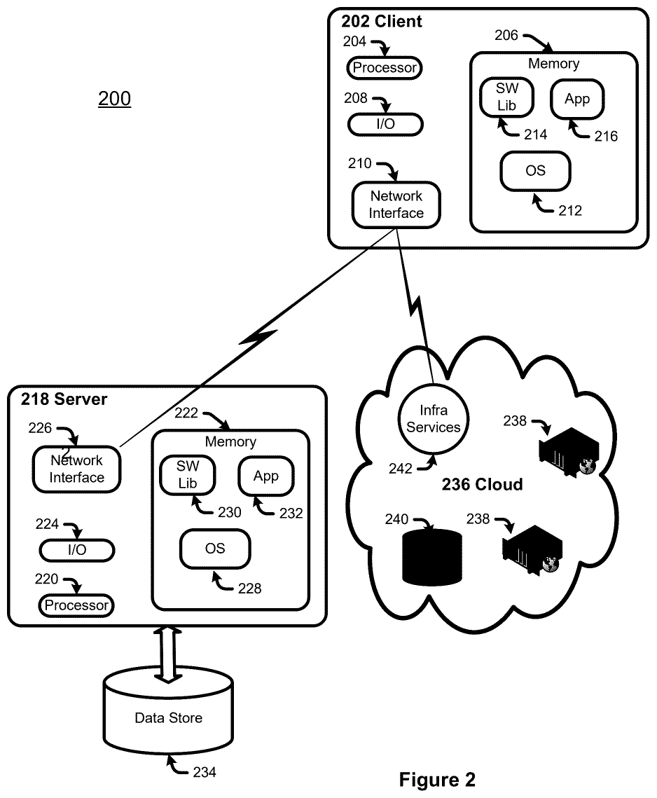

Before describing AID Agricultural Management in more detail, we describe in FIG. 2, an environment diagram 200 of an exemplary hardware, software, and communications computing environment.

### Client Platforms

The functionality for AID Agricultural Management is generally hosted on a computing device. Exemplary computing devices include without limitation personal computers, laptops, embedded devices, tablet computers, smart phones, and virtual machines. In many cases, computing devices are to be networked.

One computing device may be a client computing device 202. The client computing device 202 may have a processor 204 and a memory 206. The processor may be a central processing unit, a repurposed graphical processing unit, and/or a dedicated controller such as a microcontroller. The client computing device 202 may further include an input/output (I/O) interface 208, and/or a network interface 210. The I/O interface 208 may be any controller card, such as a universal asynchronous receiver/transmitter (UART) used in conjunction with a standard I/O interface protocol such as RS-232 and/or Universal Serial Bus (USB). The network interface 210 may potentially work in concert with the I/O interface 208 and may be a network interface card supporting Ethernet and/or Wi-Fi and/or any number of other physical and/or datalink protocols.

Memory 206 is any computer-readable media which may store software components including an operating system 212, software libraries 214, and/or software applications 216. In general, a software component is a set of computer executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes at least two types of computer-readable media, namely computer storage media and communications media. Computer storage media includes volatile and non-volatile, removable, and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

### Server Platforms

A server 218 is any computing device that may participate in a network. The network may be, without limitation, a local area network (“LAN”), a virtual private network (“VPN”), a cellular network, or the Internet. The server 218 is similar to the host computer for the image capture function. Specifically, it will include a processor 220, a memory 222, an input/output interface 224, and/or a network interface 226. Stored in the memory will be an operating system 228, software libraries 230, and server-side applications 232. Server-side applications include, without limitation, file servers and database applications including relational database applications, which manage, retrieve and store data in a database or other data store. Accordingly, server 218 may have or be associated with a data store 234 comprising one or more hard drives or other persistent storage devices. In various embodiments, the data store 234 may be configured as a database, including a relational database.

### Cloud Service Platforms

A service on cloud 236, where the “cloud” is to be viewed as remote processes and/or services available on one or more networks, such as the Internet, may provide the services of a server 218. In general, servers may either be a physical dedicated server or may be embodied in a virtual machine. In the latter case, cloud 236 may represent a plurality of disaggregated servers which provide virtual application server 238 functionality and virtual storage/database 240 functionality. The disaggregated servers are physical computer servers, which may have a processor, a memory, an I/O interface and/or a network interface. The features and variations of the processor, the memory, the I/O interface and the network interface are substantially similar to those described for server 218. Differences may be where the disaggregated servers are optimized for throughput and/or for disaggregation.

Cloud 236 and virtual application server 238 and virtual storage/database 240 may be made accessible via an integrated cloud infrastructure 242. The integrated cloud infrastructure 242 not only provides access to cloud application servers and services 238 and 240, but also to billing services and other monetization services. Integrated cloud infrastructure 242 may provide additional service abstractions such as Platform as a Service (“PAAS”), Infrastructure as a Service (“IAAS”), and Software as a Service (“SAAS”).

As stated above, cloud 236 services generally disaggregate physical servers and reaggregate them into virtual machines. This process is accomplished via a software component called a hypervisor. Virtual machines appear like a physical server, but because of the disaggregation and reaggregation process, hypervisors enable the efficient use of hardware, as the virtual machine includes only the computers/servers, data stores, and automation hardware requested, leaving excess hardware capacity to be used in other virtual machines.

Because virtual machines behave like physical servers, the time to boot up the virtual machine may take an unacceptable amount of time. To this end, containerization software, such as Google Kubernetes (TM) and Docker, enable partitions of the virtual machine (called containers), to perform compute functions on demand without boot time delay.

### Exemplary Agricultural Management System

FIG. 3 is a block diagram 300 illustrating exemplary internals for an Agricultural Management System 116.

As previously mentioned, the Agricultural Management System 116 receives input data via API 124 and in some cases performs preprocessing of input data via Data Interface 126. Data sources may include data entry from the various apps 118, 120, 122. Additionally, the Agricultural Management System 116 may receive inputs and telemetry from Sensors 302, from document feeds 304 provided by users 110, 112, 114, and from outside News Feeds 306.

### Sensor Telemetry and Preprocessing

In general, Plantation 102 is instrumented with various Sensors 302 providing automated data collection. When the data is in time series, the input data is called telemetry. Sensors 302 can include logistical sensors, such as automated weight scales, or can include typical weather sensors such as thermometers and barometers. The former (e.g., weight data) is static input data. In other words, it is not time dependent data. Other data, such as weather data, is specific to time, and is therefore dynamic and can be represented as telemetry when streamed in a time series.

In the case of regenerative farming, sensors for the plants, soil, and environment are also brought to bear. Sensors 302 include devices to measure for soil health and plant health. Examples of measurements to be made by Sensors 302 for soil health include bioactivity for the soil, degree of oxygenation, incidence of earthworms, and accessibility of soil for crops. Examples of measurements to be made for plant health include indirect measurements such as leaf color, plant size, visual detection of anomalies, fruit count and flower count. Other measurements for plant health may include direct measurements such as bark and fruit sampling. In some cases, harvested Produce 108 may be sampled and tested by Sensors 302 for nutritional content, including factors relating to taste. Harvested Produce 108 may also be sampled and tested by Sensors 302 for visual anomalies such as misshapen fruit or discoloration.

In practice, where Sensors 302 are not time dependent, data entry of static input data is most likely to be performed via the various client apps 118, 120, 122, where users 110, 112, 114 may manually enter or scan, data. The client apps 118, 120, 122 then interface with the Agricultural Management System 116 via API 124 to upload the input data.

However, where Sensors 302 are collecting telemetry, the Sensors 302 may be configured to directly provide automated feeds, called data streams, of time series data to the Agricultural Management System 116 via Data Interface 126. By way of illustration and not limitation, Data Interface 126 includes a software component called a Sensor Interface 308. The Sensor Interface is comprised of a software component that maintains a message queue, and software components, referred to as drivers, which adapt data streams from the Sensors 302. Specifically, message queues buffer data streams and enable other software components to read those streams. For each Sensor 302, Sensor Interface 308 executes a software driver that manages the particular data format of the received data, determines the data format to be entered into the queue, and manages the sample rate and timing of posting data from Sensor 302 to the message queue. In this way, Sensor Interface 308 is able to preprocess incoming data from Sensors 302 and further to enqueue data for consumption by the Agricultural Management System.

### Document Feed Preprocessing for GenAI

Beyond static data entry via the client apps 118, 120, 122, and reception of data streams from sensors 302, the Data Interface 126 can receive documents via Document Feed 304, which are files containing data. Data Interface 126 includes a software component called an Ingestion Module 310. Generally, the documents received via the Document Feed 304 are office productivity files usually of Plantation 102 operations and include documents in file formats such as Microsoft Word (TM), Adobe Acrobat™ PDF files, and Microsoft Excel (TM) workbooks. GenAI applications use documents that may be received from Document Feed 304 to bias and train inference engines to recognize data relating to Plantation 102 operations. This biasing is called Retrieval Augmented Generation (RAG). The Ingestion Module 310 populates a data store, e.g., the RAG Database 134c, for RAG operations. The Ingestion Module 310 is generally implemented via application programming interfaces for the inference engine to be used by the GenAI application.

### News Feed Preprocessing

Additionally, Data Interface 126 may receive news feeds from outside sources, generally published over the Internet. One example protocol supporting the streaming of news feeds is the Really Simple Syndication (RSS) protocol. Data Interface 126 includes a software component called a News Feed Loader 312 that incorporates an RSS client or equivalent to subscribe to and receive outside data feeds. Example data feeds include weather reports, environmental warnings, and even changes in law and regulations. In some cases, the News Feed Loader 312 will take input data from the RSS client and enqueue the input data into a message queue, in a similar fashion as does the Sensor Interface 308 described above.

### Relational Database Loading With ETL Module

In some cases, the Sensor Interface 308 and the News Feed Loader 312 receive data that is to be loaded into a relational database. Because relational databases expect data to be in a predetermined format, Data Interface 126 includes a software component called an Extract Transform Load (ETL) Module 314. The ETL Module 314 receives buffers of data to process, and as needed performs the format transformation on the data prior to loading the transformed data into the relational database. Specifically, for a Sensor 302, or News Feed 306, the ETL Module 314 takes a mapping for the format of input data enqueued in the message queue and uses the mapping to extract the data from the message queue, transform the extracted input data into a format suitable for the relational database, and then loads the transformed input data into the relational database. In this way, the ETL Module 314 performs the extract, transform, and load functions for taking enqueued data and loading into a relational database.

### Processing Specifics via the Farm State Manager

At this point, the Agricultural Management System 116 has received input data. It is now ready to process the input data. Such processing is performed by the Farm State Manager 128 and by expansion modules managed by the Expansion Module Manager 136. The Farm State Manager 128 can be understood to be a software platform, i.e., a set of common functions to perform data processing. Functionality to direct the data processing functionality in the Farm State Manager 128 to a particular agricultural management application is implemented in expansion modules. Specifically, expansion modules are software components managed by the Expansion Module Manager 136 that, in turn, call the Farm State Manager 128 to perform a particular agricultural management function. Examples of expansion modules may include, but are not limited to, a workflow manager, a financial manager, and/or a labor manager. Expansion modules are described in greater detail below.

Farm State Manager 128 includes a relational database management system called a Farm State Database (DB) 130 for performing data processing via relational queries, usually via one or more Structured Query Language (SQL) database calls. For performing predictive machine learning, it includes a software component called a Prediction Engine 132. For performing GenAI functions, it includes a software component called a GenAI Module 134. For producing outputs, it includes a software component called a Report Generator 316.

### Identifying an Optimal Beneficial Modifications to an Agronomic Workflow

According to aspects of the disclosed subject matter, in response to receiving input data from one or more of the sensors, outside document feeds, and/or new feeds, at least a first agronomic workflow of a plurality of agronomic workflows associated with operations of the Plantation is identified. As indicated, the agronomic workflow is comprised of one or more agronomic tasks to be carried out on the Plantation. This agronomic workflow is identified as corresponding to the received input data. According to various non-limiting embodiments of the disclosed subject matter, the Prediction Engine 132 may be utilized to identify the agronomic workflow corresponding to the received input data. In at least one other alternative embodiment, one or more queries may be presented to the GenAI Module 134 to identify the corresponding agronomic workflow.

The Prediction Engine 132 forms one or more queries, also referred to as inference prompts when interacting with generative AI models, according to the input data, a current state of the Plantation, and the first agronomic workflow, which queries are suitable for submission to the GenAI module. These one or more queries identify various elements of the agronomic tasks, and requests a response to suggest at least one modification to the one or more elements of the agronomic tasks. In embodiments of the disclosed subject matter, the Prediction Engine 132 may instruct the GenAI module to return its response information back in a formatted manner suitable for interpretation and processing by the Prediction Engine 132. By way of illustration, the Prediction Engine 132 may provide instructions for the GenAI Module 134 to report its analysis of each question in a JSON format. Of course, in alternative embodiments, the Prediction Engine can receive unstructured and/or semi-structured responses from the GenAI Module and transform the response into a predetermined format in which at least one predetermined field is identified and populated with data, and from which the suggested modification is identified. It should be appreciated, that while the Prediction Engine 132 submits queries to the GenAI Module 134, due at least in part to its flexibility and adaptability in processing queries of unstructured or semi-structured data, in alternative embodiments the Prediction Engine could structure the queries in a manner that it could submit them to a trained machine learning model and receive suitable responses.

As suggested above, based on the queries, each response from the GenAI Module includes an indication of a modification to at least one agronomic task of the identified agronomic workflow, and further indicates a predicted operational financial benefit for the Plantation in implementing the modification. The Prediction Engine 132 then chooses among the responses of the GenAI Module 134 to identify a modification providing an optimal predicted operational financial benefit. According to various aspects of the disclosed subject matter, the Prediction Engine 132 identifies the predicted operational financial benefit according to any one or more of short-and long-term financial results, Plantation-regenerative benefits, and financial and/or environmental externalities affecting the overall operation and success of the Planation.

### Relational Database Processing

Turning to the Farm State DB 130, it comprises a relational database manager system (RDBMS) such as Microsoft SQL Server™ or Oracle Server™. The RDBMS manages structured data tables that support join semantics. Data is stored into the Farm State DB 130 by the Data Interface 126 via the ETL Module 314, as described above. Once the data is stored in the database, the Farm State DB 130 may access the stored data using Structured Query Language (SQL) queries implemented as stored procedures. Processing supported by SQL includes the operations of record create, record retrieve, record update, and record delete.

### Predictives via AI/ML

The Farm State Manager 128 includes a Prediction Engine 132 for performing AI/ML operations. Accordingly, Prediction Engine 132 includes a software component called an AI/ML Orchestrator 132a, and one or more AI/ML Algorithms 132b implemented in software. The AI/ML Algorithm 132b is pretrained with training data. When the Prediction Engine 132 receives a query, usually in the form of data representing a present event, the query is processed by the AI/ML Orchestrator 132a, where it forwards the query to the AI/ML Algorithm 132b. The AI/ML Algorithm 132b attempts to interpret the present event as matching or recognizing a pattern within its training data, and if the recognition is within a predetermined statistical confidence score, it makes a recommendation.

One example is to receive information regarding a present event including temperature, precipitation, and barometric data and data along with month and season data. The Prediction Engine 132 may have an AI/ML Algorithm 132b trained to predict the likelihood of wildfires. The AI/ML Orchestrator 132a processes the present event data against the AI/ML Algorithm 132b which returns the likelihood of a wildfire as a confidence score. If the AI/ML Algorithm 132b returns the likelihood of wildfire above a predetermined threshold, such as 95% confidence, the AI/ML Orchestrator 132a can work with an expansion module via Expansion Module Manager 136 to recommend remedial steps.

### Genai Document Generation

Farm State Manager 128 also includes a GenAI Module 134 to perform document generation. The GenAI Module 134 is comprised of a software component called a Prompt Processor 134a, an Inference Engine 134b, and a Retrieval Augmented Generation (RAG) database 134c (or data store). The Inference Engine 134b is a large language model (LLM) such as Google Gemini (TM) or Llama (TM) from Meta. Alternatively, a small language model (SLM) such as BERT may be used for low computer memory environments.

Note that, initially, the Inference Engine 134b is trained on language data, not process data, and generally does not have any knowledge of the business operations of the Farm 102. To bias the Inference Engine 134b, business documents 304 are loaded by Ingestion Module 310 into RAG Database 134c. The RAG Database 134c is used by the GenAI Module 134 during document generation to modify Inference Engine 134b generated documents towards expected content and format.

When GenAI Module 134 receives a query called a prompt, the prompt is sent to Prompt Processor 134a where it is tokenized (e.g., converted into numerical or coded form) and preprocessed. The tokenized prompt is then sent to the Inference Engine 134b that, in combination with data in the RAG Database 134c, then generates a response document. The response document is returned by GenAI Module 134 to the requesting party or expansion module.

GenAI Module 134 is used to generate documents from input documents, such as input documents received by Document Feed 304, with knowledge of business operations as interpreted from those input documents. Scenarios include ingesting, by way of illustration and not limitation, and via Ingestion Module 304, wildfire event data and retrieving workflow data from the Farm State DB 130 and automatically generating insurance claim information. Because the documents generated by the GenAI Module 134 may contain hallucinations, GenAI Module 134 may include error checkers to detect for possible hallucinations for review by users 110, 112, 114.

### Output Post Processing via Report Generator

Upon processing by the Farm State DB 130, Prediction Engine 132, and GenAI Module 134, a unified formatted report may be generated by a software component called a Report Generator 316. Report Generator 316 can consolidate results from different data processing sources (e.g., database 130, Prediction Engine 132, GenAI Module 134) and format the data for human consumption, including the selection of font choices and the use of document templates. In other scenarios, the Report Generator 316 may generate consolidated data output for machine consumption, such as (and without limitation) generating comma separated values (CSV) files, or JavaScript Object Notation (JSON) documents.

### Processing Specializations via Expansion Modules

Up to this point, we have described processing as performed by the Farm State Manager 128. As stated above, the Farm State Manager 128 serves as a platform to provide common functionality performed for data processing, but expansion modules are directed to orchestrate the Farm State Manager's functions (e.g., relational database calls, AI/ML functionality, GenAI, and report generator postprocessing), to a specific agricultural management function.

Expansion modules are managed with a software component called an Expansion Module Manager 136. It is expected that different Plantations 102 will acquire software licenses for modules offering different functionality based on budget and will not want to purchase functionality that it either does not need or cannot afford. To enable right-sizing of purchases, specific agricultural management functionality can be purchased in a corresponding expansion module. An expansion module is a software module that supports so-called reflections calls (in computer science parlance). A reflection call is a function that describes what function calls are available in the expansion module, the location of the function call within the expansion module, and the parameters that accompany a call that function. This enables a client App 118, 120, 122 to dynamically discover what functionality it has access to, and to make use of it.

The dynamic discovery process is as follows. When a user 110, 112, 114 buys an expansion module, that expansion module is added to a cloud, or alternatively, to a local installation of the Agricultural Management System 116. The expansion module is then registered with the Expansion Module Manager 136, which notes the addition of the expansion module in a data store with tables indicating what expansion modules are loaded into the Agricultural Management System, what expansion modules have been paid for and under what licensing terms, and the memory locations of the entry points (starting function) of the loaded expansion modules. An added expansion module is then provided with memory locations for calls in the Farm State Manager 128, for example to call the Farm State Database 130, Prediction Engine 132, GenAI Module 134, and Report Generator 316. When a client App 118, 120, 122 first starts, it calls the Expansion Module Manager 136, gets an enumeration of the memory locations of the expansion modules that are both loaded and satisfy licensing terms. Example licensing terms include whether the expansion module has been paid, the specific time period of a license, a specific number of users of a license, and/or for a specific user. The client App 118, 120, 122 then goes to the memory locations of the enumerated expansion module entry points and calls each entry point. Each called entry point returns an enumeration of the functions in the expansion module, where each record enumerated includes the function name, the parameters to call that function, and an address in memory to call that function. The client App 118, 120, 122 will then create a user interface control, such as a menu, which includes the function names from the enumerated records. After the client App 118, 120, 122 has completed configuring its user interface, a user 110, 112, 114 can use that user interface to call the memory address of the function in the expansion module, which in turn accesses the corresponding functionality. In the course of performing that functionality, the expansion module will make calls as needed to the Farm State Manager 128.

The foregoing process can be illustrated with an example. Consider an expansion module for implementing compliance called a compliance manager. One of the U.S. Federal regulations for food traceability includes a law called the Food Safety Modernization Act (FSMA) Section 204. A compliance manager may implement checks for FSMA Section 204 in a function called “Food Traceability Compliance.” The compliance module is first purchased, loaded into cloud memory, and then registered with the Agricultural Management System 116, which includes indications as to where the entry points for the compliance manager, and where the entry point for the Food Traceability Compliance function is stored. In this example, assume that the Management Application 118 is to have access to the compliance module. The Management Application 118 upon startup calls the Expansion Management Module 136, discovers that it has access to the compliance module (a loaded expansion module), and accordingly receives the location and name of the Food Traceability Compliance function. The Management Application then makes a menu item called “Food Traceability Compliance”. When the Farm Manager user 110 calls that menu item, the Management Application 118 calls the function location of the Foot Traceability Compliance function in the compliance module. The compliance module may check the Farm State Database 130 in the Farm State Manager to find what pending Produce 108 inventory is to be checked. The compliance module discovers that produce lots X and Y have not yet been associated with key data elements required by FSMA 204. The compliance module automatically updates the Farm State Database 130 with work items to add those key data elements. Because the FSMA 204 requirements are new, the compliance module may call the GenAI 134 functionality in the Farm State Manager 128 to generate an introductory document to FSMA 204. The work items and the introductory document are then propagated for performance to the Farm Supervisor 112 and the relevant Field Workers 114 via the Supervisory Workflow App 120 and the Worker Workflow App 122.

The above is not intended to be limiting, but rather to illustrate how the Expansion Module Manager 136 could operate. Presently, many expansion modules are contemplated. Some are enumerated as follows.

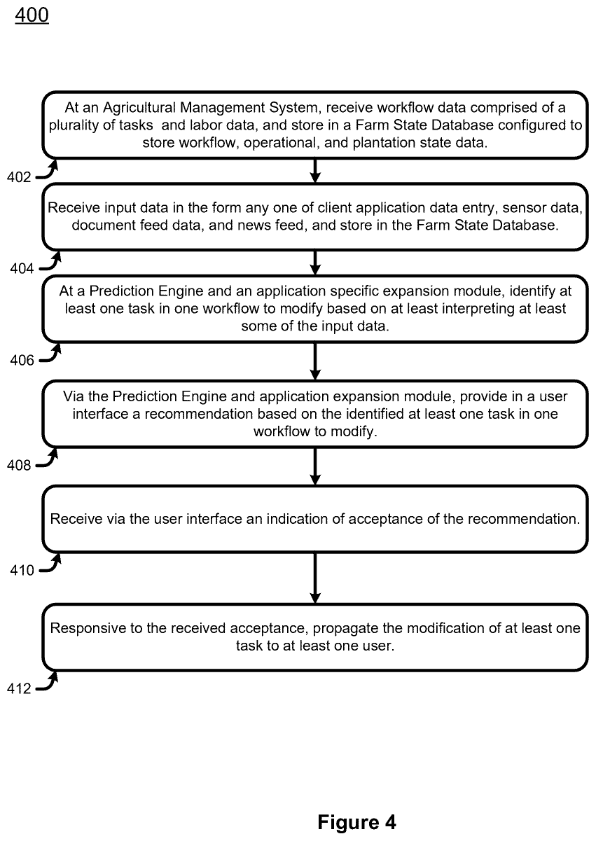

A first expansion module is the Workflow Manager 318a. Workflow is a series of tasks to perform some agronomic or related practice. The Workflow Manager 318a is able to store the different workflows of operations for a Plantation 102, and to automatically allocate those tasks to a Farm Manager 110, a Farm Supervisor 112, and/or a specific Field Worker 114 through their respective client Apps 118, 120, 122. Specifically, the client Apps 118, 120, 122 show a “to-do list” of tasks to be done with priorities and may show links to procedures and other resources. For example, the aforementioned task to ensure FSMA 204 compliance via the compliance manager expansion module may include sending a series of workflow tasks to Field Worker X and Field Worker Y to tag certain specific produce lots and a workflow task to the Farm Supervisor 112 to inspect and sign off on the tags. Field Worker Z who is not involved with tagging does not receive a change in his or her tasks. Note that the Workflow Manager 318a may call the Prediction Engine 132 to determine the priority of tasks. For example, if there is a fire on the Plantation 102, all workers may be directed to put out the fire prior to updating tags. The Workflow Manager 318a may make a notification to Field Worker A whose job it is to take the lots to market, that the task is on hold pending tagging. In this way, the Workflow Manager 318a can dynamically change and update workflows across all users. Dynamic workflow management automated with the Agricultural Management System 116 is described in greater detail with respect to FIG. 4 below.

A second expansion module is the Financial Manager 318b. The Financial Manager 318b tracks the costs of inputs and labor, projects crop yields, and revenues. The Financial Manager 318b is able to take data input of a workflow, as collected by the Supervisory Workflow App 120 and the Worker Workflow Apps 122, and track progress against those projections. In this example, the Financial Manager 318b supports “what-if” analyses. Specifically, where a workflow change is considered by a Farm Manager 110, the Financial Manager 318b can determine the financial and crop impact of that change. This is of particular interest to regenerative farming as the Financial Manager 318b is able to determine under what circumstances the application of a regenerative farming technique creates an economic advantage. Accordingly, Farm Manager 102 can consider a regenerative farming technique using the Financial Manager 318b, and then quickly deploy the changes using the Workflow Manager 318a.

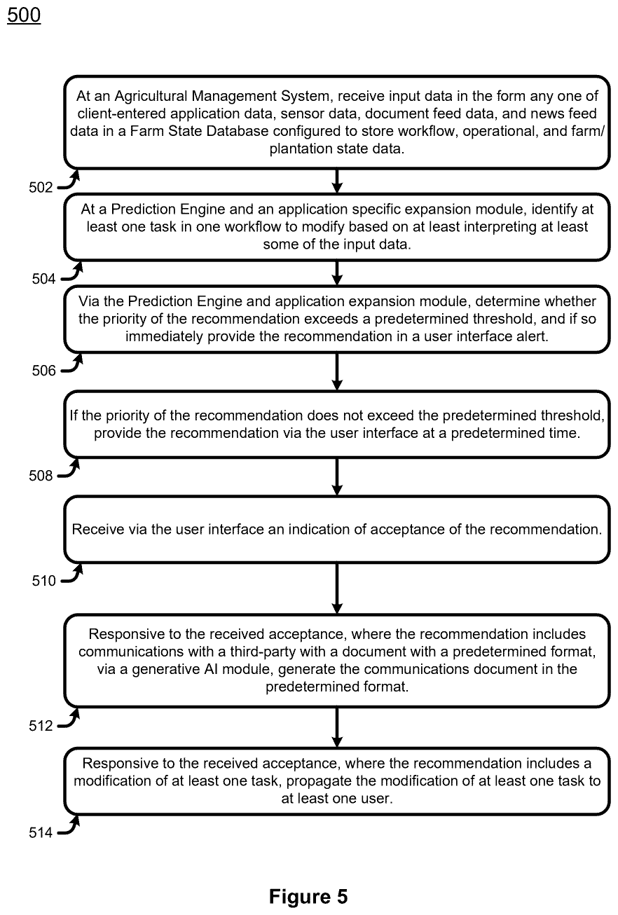

One application of the Financial Manager 318b is in regard to adaptive budgeting. Adaptive budgeting is the periodic modification of a fiscal year budget to match events. In the past, adaptive budgeting has been reactive: the Farm Manager 110 makes a best guess at expenses and revenues for a year, but when an adverse event, such as a fire occurs, the Farm Manager makes modifications to the budget. One problem with reactive budgeting is that by the time an adverse event occurs, the Farm Manager 110 may not have set aside sufficient reserves. Advantageously, as the Financial Manager 318b is predictive, it has the ability not only to recommend an annual budget, and also has the ability to predict the likelihood of adverse events and to recommend sufficient reserves. Moreover, in concert with the Workflow Manager 318a, the two may make recommendations for mitigating agronomic operations in case of those adverse events. This degree of adaptability of budget and workflow has become increasingly important with the present climate change. So-called 100-year weather events are presently occurring more frequently. The Financial Manager 318b, by adding predictive capabilities to adaptive budgeting, can mitigate the impact of climate change on a Plantation 102. Agricultural administration automated with the Agricultural Management System 116 is described in greater detail with respect to FIG. 5 below.

A third expansion module is the Labor Manager 318c. A Plantation 102 has a wide range of workers. Different workers have different skills, different compensation levels, and different labor statuses. The Labor Manager 318c tracks workers as they engage with the Plantation 102, tracks the tasks they perform, and issues as they arise. By tracking this history, the Plantation 102 can identify workers to rehire for new seasons and agronomic cycles, identify workers for additional training and promotion, and identify ideal workers to allocate key tasks to.

A key scenario of labor management is in managing overtime. Note that the Workflow Manager 318a can optimize workflow according to one or more predetermined criteria. By configuring the Labor Manager 318c to share labor cost information with the Workflow Manager 318a, the Workflow Manager 318a is able to make recommendations for what type of labor to hire, how much of that type of labor, and at what time, in order to minimize overtime, or other labor allocation inefficiencies. Furthermore, the Workflow Manager 318a can use Labor Manager 318c labor data to optimize how much lead time for recruiting and hiring, and should be used in order to ensure sufficient labor hiring at the proper time. In this way, we demonstrate the interplay between different Expansion Modules 318. The Labor Manager 318c expansion module is a form of agricultural administration automated with the Agricultural Management System 116 and is described in greater detail with respect to FIG. 5 below.

A fourth expansion module is the Compliance Manager 318d. Agriculture is a heavily regulated industry. Food is regulated. Labor is regulated. Ecology is regulated. Financing is regulated. The result is that a Plantation 102 is often beset by significant administrative overhead. That administrative overhead may be mitigated by the Compliance Manager 318d in several ways. First the Compliance Manager 318d may collect changes in law and other regulations via various sources, including news feeds 306. Second, based on the news feeds 306, workflow may be dynamically changed to ensure collection of information and compliant practice. This saves time having to redo work because of a regulation change. Finally, where reporting is to be submitted for regulatory compliance, the GenAI Module and Report Generator 316 can automatically generate, at least, a first draft of the report to save time in reporting. The Compliance Manager 318c expansion module is both a form of dynamic workflow management which is described in greater detail with respect to FIG. 4 below, and an agricultural administration automated which is described in greater detail with respect to FIG. 5 below.

A fifth expansion module is the Insurance Manager 318e. Crop insurance is Federally regulated. Accordingly, selecting insurance is often an exercise in calculating rates. However, because the Agricultural Management System 116 stores historical data, it can, via the Prediction Engine 132, determine the most pressing insurance needs for the Plantation 102. Also, the Insurance Manager 318e can track the quality of past customer experience in making claims. On this basis, Insurance Manager 318e can collect insurance carrier information via News Feeds 306 and then make recommendations as to what carriers and plans should be selected. When a claim is to be made, it is critical to ensure that complete information is provided. Because the Agricultural Management System 116 tracks workflow and indeed all aspects of plantation operations, the GenAI Module 314 and the Report Generator 316 can create at least a first draft of a claim to provide to the insurance company. This ensures a higher likelihood of successful collection and accelerates its processing. The Insurance Manager 318c expansion module is a form of agricultural administration automated with the Agricultural Management System 116 and is described in greater detail with respect to FIG. 5 below.

A sixth expansion module is the Plant and Soil Manager 318f. A Plant 104 can be conceived of as a machine that takes healthy soil, inputs, and labor and yields Produce 108. The healthier the Plant 104 and the healthier the soil, the greater the quality of the Produce 108. The Plant and Soil Manager 318f combines the tracking of plant and soil health, as collected from Sensors 302 and sampling from the performance of workflow, as well as the amount and quality of inputs and other resources used. Inputs include data regarding seed, fertilizer, and pesticides. Resources include data regarding the use of water and energy. The Plant and Soil Manager 318f can integrate with the Financial Manager 318b to balance input, resource, and labor costs against targeted quality.

A key scenario is the support of certification according to regenerative farming standards. Presently there is a proliferation of standards for what constitutes regenerative farming. Because the Agricultural Management System 116 tracks workflow, it can verify which version of regenerative farming standards the Plantation's Produce 108 qualifies for and can be certified for. In one example, consider two different certification standards, one called X Standard and the other called Y Standard. A Farm Manager 110 wishes to comply with both in order to obtain advantages both in markets that privilege the X Standard and privilege the Y Standard. Both the X Standard and the Y Standard have different criteria for agronomic practices used to qualify for the respective standards. Illustratively, via the Plant and Soil Manager 318f, workflow can be dynamically modified to ensure that both the X Standard and Y Standard certifications are complied with, and qualifying Produce 108 is tracked. The GenAI Module 134 and Report Generator 316 can generate the corresponding data reports and certification applications for both standards. In this way, both the agronomic workflow management and the certification application paperwork are automated. In fact, this automation of certification can be done not just with two standards, but an arbitrary number of standards. The Plant and Soil Manager 318c expansion module is both a form of dynamic workflow management which is described in greater detail with respect to FIG. 4 below, and agricultural administration automation which is described in greater detail with respect to FIG. 5 below.

A seventh expansion module is the Taste Module 318g. The quality of Produce 108 can be determined by nutritional content and a consumer's perceived taste. The Taste Module 318g makes correlations between the macronutrient and chemical composition of Produce 108 and perceived taste. For example, for avocados, the oil content and sugar content impact the taste and texture of the Produce 108. Terms such as “nutty” and “buttery” presently used to describe the taste of avocados can be made more precise by identifying a histogram of chemical and macronutrient ranges correlating to that taste. The Taste Module 318g tracks these ranges, and correlates workflow practices, plant/soil health, inputs/resources, and historical data such as with environment and weather with the resulting taste of Produce 108. The Taste Module 318g can direct workflow to achieve the desired taste in Produce 108. In some cases, the Taste Module 318 can generate reports where tastes are standardized to an index of the aforementioned histogram of chemical and macronutrient ranges. The Taste Module 318g expansion module is both a form of dynamic workflow management which is described in greater detail with respect to FIG. 4 below and agricultural administration automation which is described in greater detail with respect to FIG. 5 below.

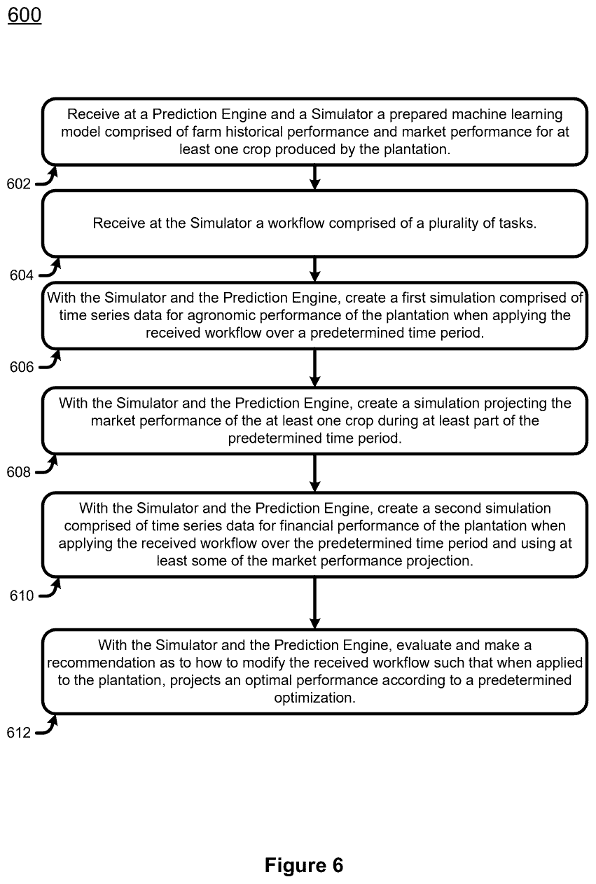

An eighth expansion module is the Simulator 318h. Recall, that the Prediction Engine 132 enables the use of AI/ML to make predictions. The Simulator 318h directs the Prediction Engine 132 to perform agricultural management specific predictions. Where the Financial Manager 318b predicts the financial result of adopting a new practice, the Simulator 318h creates a time series of data showing the progression over time There are two classes of predictions. The first relates to determining the impact of adopting a change in practice. The second relates to determining changes in the market. For both, the Simulator 318h takes data from all sources, including but not limited to Sensor data 302 captured over time, business documents 304 showing historical financials, and external news feeds 306 that provide both environmental and market data. From this data, the Simulator 318h is able to make an ML model specific to the Plantation 102 on how a particular Plant 104 will perform to yield Produce 108 creating a time series of data indicating the progression of plant/soil health, the costs of inputs/resources and labor, as well as financial performance. Regarding financial performance, the Simulator 318h is able to make predictions of what the market is likely to support in terms of produce pricing and modify financial performance predictions accordingly. The Simulator 318h is described in greater detail with respect to FIG. 6 below.

The above expansion modules 318a-318h are merely exemplary and are not intended to be limiting. It is anticipated that additional modules will be developed to address new agricultural management needs as identified over time. The range of expansion modules 318a-h shows the flexibility of the Expansion Module Manager 136 and provides an extensibility mechanism for the Agricultural Management System 116 at large.

### Exemplary Dynamic Workflow Management With Aid Agricultural Management System

Thus far we have described a wide range of applications of the Farm State Manager 128 as exemplified by various expansion modules. It is important to emphasize that the expansion modules are just examples. In general, the Farm State Manager 128 supports agricultural management of workflow, as well as overall back-office administration. Regarding the former, the use of AI/ML and GenAI enables issues to be predicted, options recommended, and upon acceptance, the recommended workflow changes dynamically propagated to users 110, 112, 114. Back-office administration automation is described in further detail with respect to FIG. 5 below. Here we turn to dynamic workflow management.

In the Agricultural Management System 116 workflows are comprised of a series of tasks, each task specific to a particular worker. Tasks may have dependencies on other tasks; before one task is done, another is to be completed first. The workflows are associated with specific results. In some cases, results are binary: they either get done or they don't. In other cases, results are quantitative: i.e., a measurable result, such as crop yield, or soil oxygenation to be achieved.

Each user has a client App 118, 120, 122 which includes an active “to-do” list comprised of tasks to be performed for the day. Different users 110, 112, and 114, and indeed different Field Workers 114 will have different to-do lists. As each user 110, 112, and 114 performs a task, the user checks that task as complete. In some cases, a task will involve uploading data such as numerical data, static data, and image, or a digital signature to provide evidence of completion. This data is uploaded via API 124 and/or Data Interface 126. Client Apps 118, 120, and 122 will also include communications infrastructure including voice, text/chat, and email. Client Apps 118, 120, 122 will also have internet connectivity so tasks can provide resource links such as training content, documentation, and database access to query the Agricultural Management System 116.

Dynamic workflow management via the Agricultural Management System 116 can be understood as a feedback loop. It receives a set of workflows. From input data it updates its information about the state of Farm 102 and its associated Plants 104, Inputs 106, and Produce 108 and any other related information. Based on the update, the Agricultural Management System 116 identifies any proposed changes to workflow. If those changes are accepted by the Farm Manager 110, Farm Supervisor 112, or an otherwise authorized party, then the workflow changes are propagated as tasks in the to-do lists for users 110, 112, and 114 via their respective client Apps 118, 120, and 122. The process then begins again. FIG. 4 is a flow chart 400 of dynamic workflow management.

In block 402, the Agricultural Management System 116 receives, via API 124, workflow data comprised of tasks, circumstance for which to use, and desired results as described above and receives labor roster information comprised of identification of workers, past history, and qualifications. The Agricultural Management System 116 stores the workflow data and the labor data in Farm State Database 130 in the Farm State Manager 128. In this way, tasks can be allocated to workers by qualification and availability.

In practice, the Agricultural Management System 116 is constantly receiving input data via Sensors 302, outside documents feeds 304, and news feeds 306. This is indicated in block 404 where this input data is uploaded to the Farm State Manager 128 including Farm State Database 130 and RAG database 134c. In this way, the Agricultural Management System 116 updates data for its current condition in near real time. Conditions tracked include but are not limited to data relating to plant health, soil health, input utilization and quality, energy utilization and quality, environmental data, production, and workflow tasks allocated and performed.

Periodically, Agricultural Management System 116 will perform a check to see whether workflows should be changed. In block 406, Prediction Engine 132 uses the incoming data from block 404 and determines whether a suboptimal or off-target event will occur.

In block 408, based on the determination by the Prediction Engine 132 and meeting a predetermined level confidence score, the Prediction Engine 132 in concert with an expansion module, such as the Workflow Manager 318a will make recommendations for changes in workflow.

In some cases, changes are motivated simply by whether the tasks already allocated are performed according to schedule, or whether there is a blocking issue such as being out of a particular resource, such as fertilizer. An example of a business modification is where a worker has called in sick causing a need for a rotation of tasks. In other cases, such as a fire, the circumstances are much more exigent, and tasks need to be immediately reallocated to handle the emergency. In yet other cases, the tasks are informed by the need to mitigate long term impacts of emergencies. For example, after a fire, soot coats the leaves of trees which attracts mites, such as the six-spotted mite and/or the persea mite. Tasks to check for mites, and to mitigate accordingly, may be recommended.

In block 410, recommended changes to workflow are presented to the Farm Supervisor 112 and his or her delegates via Supervisory Workflow App 120. The Agricultural Management System 116 can be configured to automatically accept some types of workflow. Alternatively, the Agricultural Management System 116 can provide a point where workflow changes are to be explicitly approved. To prevent recommended changes from surfacing too often as to be distracting, with the exception of emergencies, Prediction Engine 132 and Workflow Manager 318a will batch recommended changes for review at a predetermined time. However, in the case of emergencies, an alert calling attention to the issue and the recommended change may be surfaced in real time.

Upon approval, in block 412, workflow tasks are propagated in database 130 and then propagated to the client Apps 118, 120, and 122. The client Apps'118, 120, and 122 to-do lists will be updated, and an alert surfaced to the user 110, 112, and 114 calling their respective attention to the changes and any related contextual information.

In this way, workflow management is automated with changes managed dynamically. This contrasts with present management where Farm Supervisor 112 is faced with constant changes and having to verbally communicate changes to the various Field Workers 114 and related parties. With the Agricultural Management System 116, issues are proactively addressed, and where they occur in real time, the issues can be prioritized. Recommended workflow changes can be reviewed in context, and when accepted, communications and task dispatching is fully automated. Then operations continue to loop starting at block 404 again.

To illustrate the advantages of applying AI to dynamic workflow management, we consider the detection of emergencies. Because the client Apps 118, 120, 122 track voice, text/chat, and email communications, Prediction Engine 132 can monitor communications to spot issues. For example, if a first worker 114 notices discoloration on a plant, and another worker 114 reports low yield, and a sensor reports a high incidence of a particular fungus, the Prediction Engine 132 can identify a crop infection. Furthermore, Prediction Engine 132 can identify workflow changes, prioritize, and then surface recommendations to Farm Supervisor 112 based on prioritization.

Dynamic workflow shines in the case of exigent emergencies. During emergencies, communications by stressed Farm Workers 114 are often confused. The Prediction Engine 132 can monitor communications, use AI to interpret the communications, correlate the interpreted communications to environmental conditions and historical data, and alert the Farm Supervisor 112 of a likely fire. Further, through GenAI Module 134 and Report Generator 316, Farm State Manager 128 can create a central status report to make available to all stakeholders to free Farm Supervisor 112 to address the emergency. Workflow is not only dynamically reallocated to address the emergency, but also care is taken to ensure tasks that were in progress prior to the emergency are put into a non-risky state. Consider where a truck is being refueled. Prior to addressing a fire, refueling should be stopped, and the equipment put away properly. Handling the aftermath of the emergency is also automated. Not only are long term issues identified, and workflow dynamically changed, but insurance paperwork may be automated. The automation of paperwork and administrative automation is described in further detail with respect to FIG. 5 below.

### Exemplary Agricultural Administration via Aid Agricultural Management System

Agricultural administration using the Agricultural Management System 116 is analogous to the dynamic workflow management described above. The difference is that the state being reviewed is related to overall plantation performance rather than agronomic issues. Agricultural administration is understood to be a feedback loop as well. Specifically, the Agricultural Management System 116 is constantly monitoring not only the agronomic state of the Plantation (e.g., plants/soil, inputs/resources), but also labor, financial performance, regulations, and insurance issues. The state of the Plantation 102 is updated. Accordingly, Prediction Engine 132 will recommend practice changes. Practice changes may involve the generation of documentation, which the GenAI Module 134 and Report Generator 316 can automate, or the automated changing of workflow. Farm Manager 110 will accept changes, and then accordingly, task lists are updated and paperwork generated. The process then repeats. FIG. 5 is a flow chart 500 of administrative automation via the Agricultural Management System 116.

In block 502, the Agricultural Management System 116 receives data via Sensors 302, outside documents feeds 304, and news feeds 306. As in block 404 with respect to FIG. 4, plant/soil, input/resource, and workflow data are tracked. However, with administrative automation, non-agronomic factors are also considered. Via news feeds, market data may be received. Financial data and business data for the Plantation 102 may be uploaded via Document Feed 304. Because Plantation 102 has governance, regulatory, and compliance considerations, updates to laws and regulations may be received via News Feed 306. This received data is stored in database 130 and RAG database 134c.

In block 504, Prediction Engine 132, in concert with an expansion module 318, may make recommendations for a practice change. Practice changes may be agronomic in nature or may be back-office operational in nature. Examples of back-office operations include selection of insurance, and consolidation of financial reporting.

In some cases, recommendations are made for exigent emergencies. In block 506, Prediction Engine 132, in concert with an expansion module 318, may determine that the level of risk exceeds a predetermined threshold and will raise an immediate alert to the Farm Manager 110. This includes changes to the allocation of resources, and prioritization of any response.

In other cases, recommendations may be batched for longer consideration. In block 508, Prediction Engine 132, in concert with an expansion module 318 will make recommendations for operational changes. Because such decisions are usually made through a governance process, GenAI module 134 and Report Generator 316 may automatically generate financial reports showing the predicted impact of those operational changes.

In block 510, Farm Manager 110 approves of the changes. Accordingly, in block 512, paperwork is automatically generated, and in block 514, workflow changes are propagated, in a way similar to block 412 with respect to FIG. 4. Then operations continue to loop starting at block 502 again.

It is worth emphasizing that the Agricultural Management System 116 excels at the generation of documents. In many cases, the administration of Plantation 102 involves reporting and applications with arcane requirements. Because the Farm State Manager 128 stores all aspects of operations, both agronomic and back-office, and because the Agricultural Management System 116 is able to receive updates to the law/regulations and document formats, the GenAI Module 134 and Report Generator 316 are able to automate at least the beginning of report generation. Furthermore, to guard against hallucinations, the Farm State Manager 128 can put automated error checks in place. Proper use of these facilities can save administrative time and cost, and reduce errors, as to enable a Plantation 102 to focus more on agronomics and optimization, rather than administration.

### Exemplary Simulation Informed Agricultural Operations via an AID Agricultural Management System

One of the strengths of AI is the ability to do “what-if” analysis of scenarios. In order to make a decision as to whether to change practices, it is worthwhile to run a simulation of the changes. Simulations are predictions that include time series data. A prediction is static in nature, for example, that a practice change will double your yield. In contrast, a simulation is dynamic, or time dependent, for example a practice change will in fact double your yield, but also that your costs will spike in the beginning, you will have to let go of labor in the middle, and at the end you will have depleted your soil as to compromise a subsequent crop.

In the discussion regarding agricultural administration with respect to FIG. 5 above, Prediction Engine 132 in concert with an expansion module 318 made recommendations for practice changes. However, periodically a Farm Manager 110 or delegate will consider a practice change, such as whether to implement a regenerative farming technique. Simulator 318h, in concert with Prediction Engine 132, enables a Farm Manager to test out potential practice changes prior to putting into production. The Prediction Engine 132 and Simulator 318h not only make predictions and simulations for operations for a Plantation 102, but also may make market predictions and simulations, and use those results to statistically weight financial predictions and simulations. FIG. 6 is a flow chart 600 of the simulation process.

In block 602, the Simulator 318h receives a prepared AI model. In most cases, the AI model relates to performance specific to the Plantation 102. It amalgamates historical data based in plant/soil health, utilization and quality of inputs/resources, agronomic workflow practices, environmental data, regulatory issues, market data, and any other relevant available data. This model provides a best fit model between past practices, and performance of the Plantation 102.

In block 604, Farm Manager 110 enters a proposed workflow comprised of tasks. As stated above, the workflow indicates dependencies between tasks, circumstances for utilization, and target results.

In block 606, the Simulator 318h in concert with the Prediction Engine 132 will first create time series data for the performance of the Plantation 102 independent of market data. The outputs will show costs, plant health, soil health, labor and resource allocation, as well as likely events (such as increased yield, or higher likelihood of fungus). In general, market independent time series data will relate to agronomic considerations.

In order to make financial projections, it is ideal to use an estimate of the state of the market at time of harvest, rather than in the present market. In block 608, Prediction Engine 132 and the Simulator 318h make a simulation of the market at least for the projected harvest period. In block 610, Prediction Engine 132 and Simulator 318h make financial projections for the proposed practice from block 604 based on the generated market simulation.

From the non-market based agronomic performance simulation in block 606 and the market based financial performance simulation in block 610, a Farm Manager 110 may determine whether to adopt the proposed practice change. However, in block 614, the Simulator 318h and the Prediction Engine 132 have historical data and can make recommendations to the proposed practice change. In other words, the Simulator 318h and the Prediction Engine 132 actively generate proposed changes to the workflow to optimize the proposed workflow. In this way, Farm Manager 110 not only has the simulations, but also the best workflow implementation of the practice specific to Plantation 102.

Simulator 318h applies to any practice change. However, Simulator 318h is particularly useful for evaluating regenerative farming techniques. All too often, the argument to make use of regenerative farming is on the basis of sustainability. However, where profit margins are thin, and many agricultural operations face existential threats, it is more effective to show when regenerative farming practices show an economic benefit. Via the Agricultural Management System 116 and in particular via the use of Simulator 318h and AI techniques, this is possible.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer-implemented method configured to implement an Agricultural Management System in managing the agricultural workflow of a plantation, comprising:
accessing workflow data comprising a plurality agronomic workflows, each agronomic workflow a plurality of agronomic tasks to be carried out for the plantation;
receiving input data corresponding to the plantation from one of a plurality of data sources, wherein the input data corresponds to at least a first agronomic workflow of the plurality of agronomic tasks;
forming a plurality of queries according to the input data, a current state of the Plantation and the at least first agronomic workflow, the queries formed to elicit a response identifying a potential modification to an agronomic task of the first agronomic workflow, and submitting the plurality of queries to a trained Generative Artificial Intelligence (GenAI) module;
receiving responses for at least some of the plurality of queries from the GenAI module, each received response being at least semi-structured and suitably configured for processing by a trained machine learning Prediction Engine, wherein each received response includes at least:
an indication of a modification to at least one agronomic task of the at least first agronomic workflow; and
a predicted operational financial benefit for the Plantation arising from implementing the modification to the at least one agronomic task;
identifying a first received formatted response of the received formatted responses having a predicted optimal operational financial benefit for the Plantation arising from the implementation of the indicated modification to the at least one agronomic task; and
generating a recommendation to perform the identified modification to the at least one agronomic task of the at least first agronomic workflow, the recommendation articulating the indicated modification substantively in human readable form.

2. The method of claim 1, wherein plurality of data sources includes one of:
sensors capturing sensor data from one or more locations of the Plantation;
outside document feeds providing documents corresponding to environmental factors that affect the Plantation; and
news feeds identifying information relevant to at least one agronomic workflow of the plurality of agronomic workflows for the Plantation.

3. The method of claim 1, wherein the input data relates to any one or more of:
plant health data of the Plantation;
soil health data of the Plantation;
a quantity of water, fertilizer, or pesticide for application to the Plantation;
a quality of water, fertilizer, or pesticide for application to the Plantation;
environmental data likely to affect the productivity of the Plantation;
current or historical production data of the Plantation; and
workflow progress data of a currently implemented agronomic workflow of the plurality of agronomic workflows.

4. The method of claim 1, wherein the input data further comprises labor data including any one of worker activity on the Planation, worker labor costs associated with worker activity on the Plantation, and worker availability for working on the Plantation.

5. The method of claim 1, wherein forming the plurality of questions according to the input data, a current state of the Plantation and the at least first agronomic workflow further comprising including instructions to the GenAI module to provide responses according to a structured format suitable for processing by the trained machine learning Prediction Engine.

6. The method of claim 1, wherein the GenAI Modulate comprises a Retrieval Augmented Generation Database (RAG DB), and wherein the method further comprises, upon receiving input data comprising a document file, populating the RAG DB with the received document file for retrieval augmented generation.

7. The method of claim 1, the Agricultural Management System comprises at least one of a plurality of software Application Specific Expansion Modules;
wherein each Application Specific Expansion Module is configured to, at least, identify at least one agronomic task in one agronomic workflow to modify in accordance with received input data; and
wherein each of the plurality of questions includes a potential modification to an agronomic task of the at least first workflow.

8. The method of claim 7, wherein the at least one Application Specific Expansion Module is any one of:
A workflow manager expansion module;
A financial manager expansion module;
A labor manager expansion module;
a compliance manager expansion module;
a insurance expansion module;
a plant/soil manager expansion module;
a taste expansion module; and
a simulator expansion module.

9. The method of claim 1, wherein the at least one agronomic task is a non-regenerative agronomic task, and wherein the modification to the at least one agronomic task replaces the non-regenerative agronomic task with a regenerative agronomic task in the first agronomic workflow.

10. The method of claim 1, further comprising:
presenting at a first instance of a software user interface the generated recommendation;
receiving from the first instance of a software user interface, an acceptance of the generated recommendation; and
in response to receiving the acceptance of the generated recommendation, propagate the modification of the at least one agronomic task to the first agronomic workflow.

11. The method of claim 10, wherein the generation of the recommendation includes generating a priority for the recommendation, and wherein the method comprising determining whether the generated priority of the recommendation exceeds a predetermined threshold.

12. The method of claim 11, wherein upon determining that the generated priority of the recommendation exceeds the predetermined threshold, providing an indication of the recommendation in at least one instance of the software user interface in the form of an alert.

13. The method of claim 12, further comprising:
receiving, from the software user interface, a user acknowledgement of the alert; and
responsive to receiving the user acknowledgement, generating a communications document according to a predetermined format.

14. The method of claim 13, wherein the predetermined formats are any one of:
a format for a legal document;
a format for a regulatory document; and
a format for an insurance document.

15. The method of claim 13, wherein each received response is at least semi-structured as a JSON-structured file.

16. A computer-implemented Agricultural Management System for managing agricultural workflow of a plantation, comprising at least:
a computer processor;
a computer memory configured to store computer readable instructions, the instructions including an executable Simulator that, in execution on the Agricultural Management System, carry out the operations comprising, at least:
accessing plantation historical performance data and market performance data for at least one crop produced by the plantation;
accessing an agronomic workflow implemented by the plantation with respect to the at least one crop, the agronomic workflow comprising a plurality of agronomic tasks;
generating a first simulation according to a set of time series data corresponding to agronomic performance of the plantation when applying the agronomic workflow over a predetermined time period;
projecting a market performance of the at least one crop over at least part of the predetermined time period according to results of the first simulation;
generating a second simulation according to a set of time series data corresponding to financial performance of the plantation when applying the agronomic workflow over the predetermined time period, and also in view of at least some of the projected market performance; and
based on an evaluation of the results of the first simulation and the second simulation, generating a recommendation of a modification to the agronomic workflow such that when the modification applied to agronomic workflow, results in an predetermined optimization for the plantation.

17. The Agricultural Management System of claim 16, wherein the modification to the agronomic workflow comprises one or more modifications to the plurality of agronomic tasks of the agronomic workflow.

18. The Agricultural Management System of claim 16, wherein the predetermined optimization is a financial benefit optimization for the plantation.

19. The Agricultural Management System of claim 16, wherein the modification to the one or more modifications to the plurality of agronomic tasks of the agronomic workflow comprises replacing at least one non-regenerative agronomic task of the plurality of agronomic tasks a regenerative agronomic task.

20. A computer-implemented Agricultural Management System suitably configured to manage agricultural workflow of a plantation, comprising:
a computer processor,
a computer memory configured to store computer readable instructions, the instructions configured to, in execution:
access workflow data, the workflow data comprising a plurality of agronomic workflows, each agronomic workflow comprising a plurality of agronomic tasks to be carried out on or with respect to the plantation;
receive input data from one or more external data sources and processing the received input data into one or more input queries for submission to a generative AI (GenAI) module, each input query being a request for a modification to at least one workflow of the plurality of workflows;
submit the one or more input queries to the GenAI module and receive a correspond one or more modification responses;
evaluate the one or more modification response to identify at least a first agronomic task in a first agronomic workflow for modification, wherein the identification of the first agronomic task is determined by the evaluation according to an operational financial benefit resulting from the modification of the first agronomic task;
generate a modification recommendation for presentation to a person to perform the identified modification on the first agronomic task of the first agronomic workflow, the recommendation articulating the identified modification first agronomic task substantively in a human readable form and submit the recommendation for presentation to the person;
receive from the person an acceptance of the modification recommendation; and
propagate the modification of the first agronomic task in the first agronomic workflow.
